(19) United States
(12) Patent Application Publication
(10) Pub. No.: US 2025/0371637 A1
(43) Pub. Date: Dec. 4, 2025

(54) SYSTEM AND METHOD FOR IMPLEMENTING DIRECT DEMOCRACY

(71) Applicant: Larry M. Shultz, Beverly Hills, CA (US)

(72) Inventor: Larry M. Shultz, Beverly Hills, CA (US)

(21) Appl. No.: 18/731,528

(22) Filed: Jun. 3, 2024

(51) Int. Cl. G06Q 50/26; G06Q 50/00

(52) U.S. Cl. CPC G06Q 50/26; G06Q 50/01; G06Q 2230/00

(57) ABSTRACT

The present method for implementing direct democracy includes utilizing surveys or polls related to the legislative process or issues that are shared with multiple users for gauging the voter's opinion on the legislative process. The disclosed invention captures voters/users/subscribers' opinions on the legislative process and integrates it with the opinion or voting pattern of their elected representative. The proposed system and method analyze and continually monitor the voting behavior of the elected representative and simultaneously inform the subscribers. The system and method incorporate various modules to hold the elected representative accountable for their voting behavior towards a legislative bill that may affect the subscribers registered on the system. Several deterrent measures are specifically designed to force the elected representative to follow the will of the people, thereby committing to the promises made towards their constituencies during their election campaign.

### FIELD OF THE INVENTION

The present invention relates to a social computer networking system and a method for online platforms to increase the accountability of political candidates and elected representatives to their respective constituent voters by amplifying the opinions and voices of their voters to influence and compel elected representatives to vote for-or-against new and pending legislation according to the will of the people in any parliamentary democracy or representative democratic republic.

### BACKGROUND

In the pantheon of governance, Direct Democracy stands as the epitome of civic engagement, where all citizens who are eligible to vote take an equal part in the process of making the laws that govern them by casting votes directly on needed laws to solve societal problems. Historically, the implementation of such a direct voting system on a grand scale has been hindered for centuries by the total absence of technologies capable of managing and swiftly processing the votes of millions of citizens spread out over long distances, since voting results and national news were previously only spread person-to-person by horseback until the invention of the telegraph. The advent of electricity, computers, telecommunications, and other technological advancements needed to enable Direct Democracy were yet to be invented.

Direct democracy, which entrusts the general populace with the power to propose, amend, pass, or veto laws directly, was often deemed impractical by elites throughout history. This skepticism stemmed from a belief that the average voter lacked the necessary character and intellect to make such significant decisions. Elites feared that without proper education and a vested interest in the state's long-term well-being, voters might be swayed by fleeting passions or demagogues, leading to instability and imprudent legislation. They argued that the complexities of law and governance required a level of expertise and foresight beyond the reach of the common citizen. Consequently, many societies opted for representative democracies, where elected officials, presumed to have the requisite knowledge and judgment, make decisions on behalf of their constituents.

For these reasons, the Founding Fathers of American democracy, and all other parliamentary governments worldwide, embraced and enshrined into their governing Constitutions the more practical model of Representative Democracy that didn't require the simultaneous participation of its citizens to make laws, but only to follow them. In Representative Democracy, each citizen as a voter vests governing authority in elected representative officials to whom the voter entrusts their proxy to pass laws for and on behalf of the people, based on candidates and elected representatives promising to address and fix those local, and state or national problems impacting its citizens. This structure creates a reciprocal voter-centric relationship and mutual exchange between voters and candidates running for office—whereby Voters voice their concerns and priorities to their representative lawmakers, who promise to address these issues, thereby fostering a seemingly responsive and accountable relationship with voters.

Yet, as written in state and federal Constitutions and their official Oaths of Office, these elected representatives are not legally bound and have no obligation, to legislate according to the will of the people who elected them. The only power that voters currently have over their elected representatives under the law is every two years on election-day to vote out unaccountable representatives or gather petition signatures for a Recall Election or unlikely legislative impeachment. Otherwise, elected representatives are free to act as they alone decide on every proposed law or amendment to a bill as it makes its way through every Congressional or state legislature committee.

While there is no functioning direct democracy in the world that provides its citizens the right and obligation to directly propose and pass laws according to the wants and needs of its citizenry, it is highly desirable to enable citizens of any parliamentary democracy or representative democratic republic to nonetheless empower themselves to directly propose and pass laws within the legal confines of any representative democracy.

Having said that, legislative measures enacted by politicians have, in certain instances, made it more challenging for local, state, and U.S. citizens to participate in the democratic process. Consequently, elected representatives may not fully reflect the preferences of the majority of citizens, resulting in a governance system where decisions are made by a minority of citizens.

This lack of proportional representation has created a pressing social need for a more effective and innovative approach to motivating the majority of citizens to participate in the electoral process.

Unfortunately for most voters, the accountability of their elected representatives has reached the same all-time low as voters' approval rating of Congress. A majority 60% of all eligible voters in America are now unaffiliated voters (80 million non-voters and 65 million independent voters) who abandoned the two-party system of Democrats and Republicans—even though virtually every candidate running for election to a State Legislature or Congress is a Democrat or Republican. This paradox demonstrates the need for a non-partisan solution in favor of voters holding their elected representatives accountable for how they vote on social issues the voters care about as a priority. Why would the majority of American voters who left the Democrat and Republican parties to become “unaffiliated voters” now willingly vote for representatives who are members of, and loyal to, the Democrat Party or the Republican Party and their corporate donors? Most likely, they won't willingly vote for party candidates—unless they have to.

There are 15,114 bills and resolutions currently pending before the United States Congress and amongst these, there are 14,025 bills and resolutions that have been introduced or reported by committee and await further action, but of those only about 7% will become law. (based on https://www.govtrack.us/congress/bills/)

A bill and a resolution are two forms of legislative proposals that members of Congress or state legislatures vote on, but they serve different purposes and have different implications. Bills are proposed laws subject to a state Governor's or the President's approval that can affect voters' lives, personally—so many voters may appreciate the ability to exercise their rights to tell their elected representatives how to vote for or against such proposed law and its amendments during the legislative process. Resolutions are expressions of opinion or decisions that do not require the President's approval and do not affect voter's lives, personally. It's important for citizens to stay informed about the legislative calendar and to participate actively in the democratic process by providing timely feedback on proposed and active bills to their elected officials.

For every session of every state legislature and U.S. Congress, citizens can currently track bills and resolutions, including schedules for amendments and voting, through legislative-tracking resources like GovTrack.us and the House of Representatives Schedule. These platforms provide information on what is coming up for debate and when citizens can engage with their representatives to share their opinions on pending legislation.

Yet, citizens have no effective mechanism after being informed about a bill to impact its passage beyond just privately contacting their local representative by mail, email, or phone call to express their support or displeasure (which the representative can legally ignore).

At a minimum, there are usually at least three key moments when voters can directly lobby their elected representatives on how to vote on a proposed bill: during committee consideration, during the amendment process, and before the final vote. Citizens have several opportunities to provide feedback to their elected representatives at various stages of the legislative process, including:
At the time of the Introduction of Bills, that is when a bill is introduced in Congress or state legislatures, citizens can contact their representatives to express their views. This is the first opportunity for feedback;
During the Committee Stage, that is once a bill is assigned to a committee, citizens can submit their opinions during public hearings or directly to committee members. This is a critical stage where bills are examined in detail; and
After Committee Approval, that is if a bill is reported favorably by a committee, it moves to the floor for consideration. Before the floor vote, there is usually a period during which citizens can lobby their representatives.
At the Amendment Stage wherein both in committees and on the floor, bills can be amended. Citizens can suggest amendments to their representatives or advocate for/against proposed amendments.
At the Final Vote, that is, before the final vote, citizens have another chance to contact their representatives to influence their vote.
At the Conference Committee, that is if the House and Senate pass different versions of a bill, a conference committee is formed to reconcile differences. Citizens can provide input to influence the final version of the bill.
Before Presidential Signature: After Congress passes a bill, but before it is signed by the President, citizens can still express their views, potentially influencing the President's decision to sign or veto.

Nonetheless, there is an unmet need to provide a system and method that allows voters to hold their elected representatives accountable for their actions in a modern version of Direct Democracy self-governance to be implemented within the existing framework of America's Representative Democracy system. There is also a need for a system and method wherein up-to-date information related to legislative actions, such as bills, laws, amendments, and the like, is shared among the voters to gather opinions of local communities. There is a need where the opinions of the voters to be effectively raised in front of the respective elected representative and for actions to be taken in line with the opinions of the voters thereby reducing voters' dissent towards the democratic process.

### OBJECTIVE OF THE INVENTION

The present invention aims to address the aforementioned issues of effectively voicing voter concerns to an elected representative and holding such elected representatives accountable for not addressing those voter concerns at every stage of a proposed law as it makes its way out of a committee and into a formal law. The shortcomings faced in the known system are having a direct say over the laws being passed by Legislators.

An objective of the present invention is to use the time afforded by the many different votes required in the legislative process that takes weeks and months to pass a bill from a proposed law in a committee to an official law enacted by the legislature as the basis for voter involvement to give their opinion on the latest version of a bill becoming law—and either veto it or amendment.

A further objective is to incentivize an individual and/or community who create and bring a constructive understanding of the various legislative actions undertaken by the elected representative to uninformed voters of a constituency. Further, the present invention also incentivizes the voters who help in disseminating such constructive messages to gather general opinion, thereby contributing to the construction of a concrete actionable step for an elected representative, thereby increasing confidence in the democratic process.

Another objective of the present invention is to enable national and state elected representative and political action committees that have hundreds of candidates to take note of the issues concerning a community by sending opinion and survey results on every political issue that is decided by hundreds of millions of potential voters nationally simultaneously publishing them on various social media platforms for voters to keep track of the actions thereby promoting accountability of the elected representatives.

It is a further object of the present invention to make it easy for unaffilated voters to vote for and elect Republican and Democrat candidates running for office, by putting the power of Direct Democracy into the hands of every unaffiliated unaligned voter to vote, not for party candidates, but for election issues and problems that voters want fixed. While they may be disenchanted with the candidates, these voters will vote for solving the issues and fixing problems that directly impact their lives and wallets.

It is also an object of the present invention to bring disillusioned and disenfranchised unaligned voters back to the issues, and to bring accountability of candidate campaign promises to voters by flipping the script on the two-party system—shifting real-time day-to-day political power into the hands of every voter with a smart-phone.

It is an object of the present invention by implementing an Elected Representative Accountability system using social media that enables voters to dictate to their elected representatives how to vote on pending legislation using an ever-escalating series of public notices and other deterrent acts to compel Representative compliance with the will of the people for every proposed law that will impact local voters by every state legislature and Congress.

### SUMMARY OF THE INVENTION

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only, and is not intended to limit the scope of the present disclosure.

In accordance with an aspect of the present invention, a computer-implemented system, and method for facilitating participative, direct democracy related to social issues is disclosed. Said system comprises a host computer or server, a plurality of user devices communicatively connected to said host computer via a communication network.

In an embodiment, said computer-implemented online system for facilitating participative, direct democracy comprising a host computer in communication with a plurality of remote user devices connected over a communication network, wherein the host computer is adapted to store and process data of a plurality of users registered with the system through respective remote user devices, and wherein the host computer further comprises: a virtual Alert module configured to retrieve information about one or more legislative activities in real-time and their corresponding geographical location from at least one legislation-tracking database.

In another embodiment, a communication module is configured to notify said legislative activities in real-time to one or more users associated with each remote device according to their geographical location and receive requests to generate one or more opinion polls for said legislative activities.

In yet another embodiment, a virtual survey module configured to generate one or more opinion polls for each one of the legislative activities, and transmit via a communication module said opinion poll to users based on said requests; a survey feedback processing module configured to collect and analyze responses of said opinion poll and publish the results of the opinion poll.

In a further embodiment, the survey feedback processing module is configured to share the results of each of the opinion polls with one or more elected representatives in a given Parliament/Congressional setup corresponding to the geographic location of the said elected representatives;

In an embodiment, a legislator compliance module is configured to monitor and compare the results of the opinion poll with a voting action of each of the one or more elected representatives towards one or more legislative activities, wherein the legislator compliance module is further configured to: send the one or more elected representatives a notice of agreement if the voting action of the one or more elected representatives aligns with the results of the opinion poll, or send the one or more elected representatives a notice of disagreement if the voting action of the one or more elected representatives do not align with the results of the opinion poll.

In an embodiment, each of the plurality of remote user devices includes at least a user interface to display information and receive responses, and a communication module to receive and transmit information to said host computer. In another embodiment, the plurality of remote user devices is selected from smartphones, tablets, wearable devices, laptops, and smart home devices.

In an embodiment, the legislation-tracking database is selected from a federal database maintained by the federal government, a state database maintained by a state legislative body, or a private/corporate legislation-tracking database owner/provider

In an embodiment, the virtual alert module is further configured to filter one or more legislative bills using an Artificial Intelligence (AI) based filtering algorithm.

In a further embodiment, said AI-based filtering algorithm is configured to filter one or more legislative bills based on at least one of a subject matter of the bill compared to a list of top trending national political issues, local political Issues relevant to local voters, the likelihood of passage of the legislative bill, or the impact of the legislative bill on individual states or localities of local people.

In an embodiment, the survey feedback processing module is configured to anonymize user responses before sharing the results of the opinion polls with one or more elected representatives.

In an embodiment, the legislator compliance module is configured to continually send the notice of disagreement for each legislative action until the voting action of one or more elected representatives aligns with the results of the opinion poll.

In another embodiment, the legislator compliance module is configured to create and add names and websites of each of the elected representatives to a blacklist to whom at least one notice of disagreement is sent, and further notify said elected representative of the blacklist.

In a further embodiment, the legislator compliance module is configured to generate and send an online PR press release of disagreement to users, within the voting district of the one or more elected representatives added to said blacklist, and to celebrity members for sharing on social media websites.

In yet another embodiment, the legislator compliance module is further configured to implement additional deterrents or punishments selected from a predetermined list of deterrents linked with the number of times a notice of disagreement is sent to one or more elected representatives.

In another embodiment, the legislator compliance module is configured to remove the name and website of each of the elected representatives from the blacklist if the voting action of said elected representative aligns with the results of the opinion poll and publicizes the same.

In a further embodiment, the legislator compliance module is configured to update the surveys for local voters if the voting action of said elected representative aligns with the results of the opinion poll and notifies one or more users.

In an alternate embodiment, the host computer further comprises a user reward module to reward each user who reviews, discusses, and votes on the legislative bills fetched from at least one government website.

In another aspect of the present invention, an online method for facilitating participative and direct democracy related to social issues is disclosed.

In accordance with an embodiment, said method comprises registering and storing a plurality of user data received from a plurality of remote user devices; accessing information related to one or more legislative activities from at least one governmental database in real-time; broadcasting a notification related to said one or more legislative activities and their corresponding geographical locations to the plurality of remote user devices; receiving a request from one or more remote user devices for generating one or more opinion poll based on the broadcasted legislative activities; generating and transmitting one or more opinion poll based on the said request received from one or more remote user devices; collecting and analyzing responses regarding said one or more opinion poll, and publishing the results of the opinion poll.

In accordance with another aspect, the method further comprises: sharing the results of each opinion poll with one or more elected representatives in a given Parliament/Congressional setup corresponding to the geographic location of the said elected representatives;

In a further aspect, the method further includes monitoring and comparing the results of the opinion poll with a voting action of each of the one or more elected representatives towards one or more legislative activities, wherein the method is configured for sending the one or more elected representatives a notice of agreement if the voting action of the one or more elected representatives aligns with the results of the opinion poll, or sending the one or more elected representatives a notice of disagreement if the voting action of the one or more elected representatives does not align with the results of the opinion poll.

In an alternate aspect, said broadcasting step includes filtering said one or more legislative bills using an Artificial Intelligence (AI) based filtering algorithm. In another aspect, said AI-based filtering algorithm is configured to filter one or more legislative bills based on at least one of a subject matter of the bill compared to a list of top trending national political issues, local political Issues relevant to local voters, the likelihood of passage of the legislative bill, the impact of the legislative bill on individual states or localities of local people, or a user-determined preference.

In an aspect, said publishing and sharing steps include anonymizing the user responses to protect user identity.

In an aspect, the monitoring and comparing step includes transmitting repetitively the notice of disagreement until the voting action of one or more elected representatives aligns with the results of the opinion poll.

In another aspect, said monitoring and comparing step includes creating a blacklist and adding the name and website of one or more elected representatives to whom at least one notice of disagreement is sent, and notifying respective elected representatives of said addition.

In a further aspect, said monitoring and comparing step includes publicizing continually the blacklist at a pre-determined interval in all voting districts.

In yet another aspect, said monitoring and comparing step further includes generating and transmitting an online PR press release of disagreement to users within the voting district of the blacklisted elected representatives, and to celebrity members for sharing on social media websites.

In another aspect, said monitoring and comparing step further includes implementing additional deterrents or punishments selected from a predetermined list of deterrents based on the number of times the notice of disagreement is sent to one or more elected representatives.

In yet another aspect, wherein said monitoring and comparing step includes removing the names and websites of each of the elected representatives if the voting action of said elected representative aligns with the results of the opinion poll.

In a further aspect, the monitoring and comparing step includes updating the generated opinion poll if the voting action of said elected representative aligns with the results of the opinion poll and notifying one or more users.

In an alternate aspect, said method further comprises rewarding each user who reviews, discusses, and votes on the legislative bills fetched from at least one government website.

Various objects, features, aspects, and advantages of the inventive subject matter will become more apparent from the following detailed description of preferred embodiments, along with the accompanying drawing figures in which the same numerals represent like components.

### BRIEF DESCRIPTION OF THE DRAWINGS

Non-limiting examples of the present disclosure will be described in the following disclosure with reference to the appended drawings, in which:

FIG. 1 illustrates an exemplary network diagram for implementing an online system for facilitating participative, direct democracy political issues, according to an embodiment of the present invention;

FIG. 2 illustrates a detailed flow diagram of a method to facilitate the working of the online system for facilitating participative, direct democracy on political issues of FIG. 1, according to an embodiment of the present invention;

FIG. 3 illustrates the key features, and workflows of the online system for facilitating participative, direct democracy, according to an embodiment of the present invention.

### DETAILED DESCRIPTION OF THE DRAWINGS

Some embodiments of this invention, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present invention, the preferred, systems and methods are now described.

The present invention discloses an innovative platform to increase the accountability of political representatives to their respective voters and, in particular, relates to utilizing aggregating and educating different communities of voters on various social causes/political issues that their political representative should address based on their opinions/suggestions, thereby fostering a more inclusive and representative democratic system.

It is crucial for the citizens to remain informed about the legislative calendar and actively participate in the democratic process by providing timely feedback on proposed and active bills to their elected officials. Citizens can track bills and resolutions, including schedules for amendments and voting, through legislative-tracking resources such as GovTrack.us and the House of Representatives Schedule. These platforms offer detailed information on upcoming debates and the appropriate times for citizens to engage with their representatives to share their opinions on pending legislation.

There are several key stages in the legislative process when voters can directly lobby their elected representatives on how to vote on a proposed bill. Even before the final vote, citizens have another chance to contact their representatives to influence their decision. There shall be further opportunities even after the final vote and until the President signs a bill passed by Congress, where the voters can potentially influence the final outcome of the bill.

Thus, users have several opportunities to vote on amendments for every newly proposed legislative bill in their state legislature and Congress that affects them at various stages of its cycle before becoming a law.

Towards this end, the present disclosure discloses a method and a system that empowers voters to have a direct impact on the legislative process. The system and/or method enables voters to mimic the actions of their elected representatives to vote on the amendments of proposed laws in committee. This allows voters to “virtually” exercise their rights and express their opinions on every law before their state legislatures or Congress by virtually voting or virtually vetoing proposed legislation—giving users a direct say in the legislative process.

For example, if there's a proposed bill about healthcare reform, users can vote on various amendments, such as provisions for pre-existing conditions or the extent of coverage. The results of this virtual voting are then used to guide the votes of the voters' elected representatives according to the dictates of the majority of the people in the voting district who voted. Their survey results inform their representatives how to vote on the amendments and how to vote on bills in Congress that their local constituent voters want passed.

In another example, if Democrat candidates are the only politicians in 2024 who are promising to support the laws that restore Roe (pro-choice), protect voting rights and LGBTQ equal marriage rights—fixing the issues/problems that Democratic constituents, non-voters and independent voters alike want fixed—then despite their personal opinions of such Democratic candidate, an unaligned voter will still turn out to vote for the passage of these policies, if that's the successful and meaningful result of their vote.

The key features of the invention and the advancement it provides are highlighted below:
Detailed Survey Features: The system is implemented by a user application installed on their respective devices which includes Real Time Legislation Tracking feature that updates from legislative committees, ensuring voters have the latest information on laws and amendments being considered. Voters can review each amendment in detail by utilizing a Microlevel Engagement feature and provide their input through the survey, effectively micromanaging the legislative process. The results of these surveys are then compiled and shared with legislators through a Legislator Integration feature, providing them with a clear picture of their constituents' opinions on each specific amendment.
Ensuring Voter Influence: Legislators can use the survey results to align their committee votes with the will of the people by utilizing the Committee Vote Alignment feature, ensuring that the laws passed are reflective of the voters' desires. A Feedback Loop mechanism provides feedback to the voters, showing how their input has influenced legislative decisions, thereby closing the loop between voter opinion and legislative action.
Rights and Responsibilities: Voters have the right to express their opinions on laws that affect their lives by making use of the Expressing Opinions feature, and the Virtual Veto feature facilitates this by providing a platform for their voices to be heard. By participating in these surveys, voters contribute to the informed decision-making process of their elected officials, ensuring that democracy functions as intended.

In essence, the inventive features of the disclosed system and method are powerful tools for direct democracy, allowing voters to exercise their rights and influence the laws that govern their lives in a very direct and tangible way. It's a step towards a more engaged and responsive legislative process, where the opinions of the electorate are not just considered but are integral to the shaping of public policy.

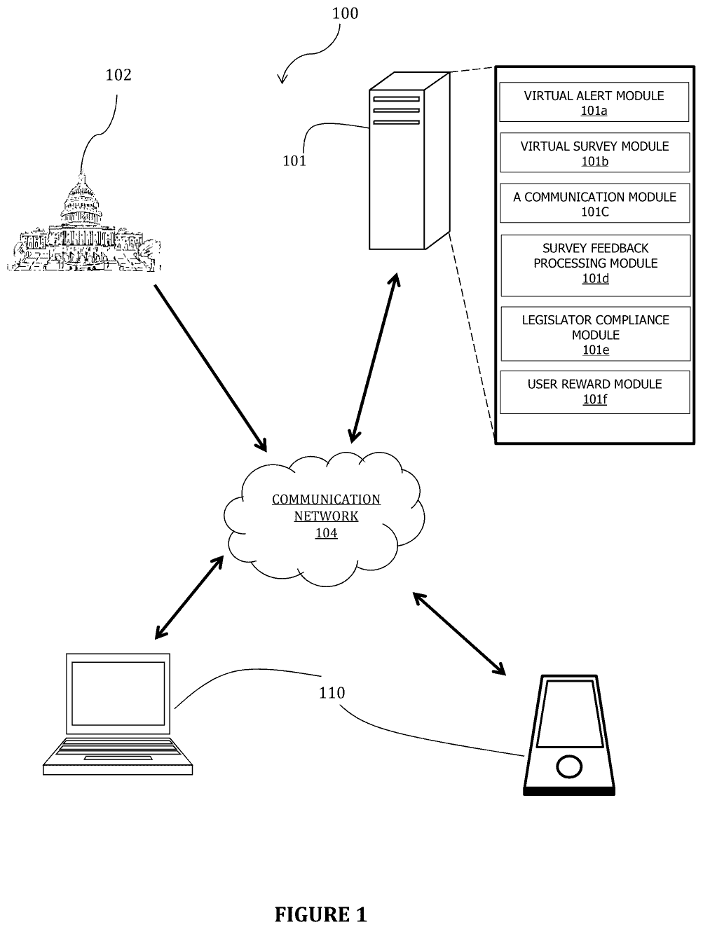

FIG. 1 illustrates an exemplary implementation of an online system 100 for facilitating participative, direct democracy for political issues, according to an embodiment of the present invention.

Said system 100 includes an online database 102 which may include public legislation-tracking databases such as, but are not limited to, databases managed by the Library of Congress, the U.S. Government Publishing Office (GPO), official websites of the U.S. House of Representatives and the U.S. Senate, and the like, which provide detailed information on legislative bills, and representations, their progress through the legislative process, and related documentation, ensuring comprehensive data coverage. The inclusion of such public databases ensures that system 100 has access to reliable and up-to-date information directly from official sources.

In addition to public databases, system 100 may integrate various private databases. These may include proprietary data sources or subscription-based services that offer in-depth analysis, specialized datasets, or additional metadata not available in public repositories. For example, private databases might include political candidate's websites, which provide insights into candidates' voting behaviors, policy positions, campaign promises, and other relevant information. By combining data from both public and private sources, system 100 is adapted to deliver a more nuanced and comprehensive view of the legislative landscape and political activities.

Said system 100 also includes a communication network 104, either a wireless technology, such as Wi-Fi, Bluetooth, or cellular networks, or wired technology, including Ethernet or fiber optic connections, depending on the specific requirements and infrastructure of the deployment environment, and is utilized for facilitating efficient data retrieval and processing by the system 100. The versatility of the communication network 104 ensures robust and reliable connectivity tailored to different operational needs.

Said communication network 104 facilitates the exchange of information among the database 102, a server 101, and a plurality of remote user devices 110. The communication network 104 establishes a link between said database 102, the user devices 110, and the server 101, enabling seamless data transmission and reception. By leveraging the communication network 104, system 100 can efficiently process requests, handle data storage and retrieval, and execute various applications critical to the system's operation. The integration of both wired and wireless technologies within the communication network 104 allows for flexibility in server placement and scalability, accommodating a wide range of system configurations.

Furthermore, the network 104 between the server 101 and the remote user devices 110 is designed to be secure and efficient. For this purpose, system 100 employs advanced encryption protocols and authentication mechanisms to protect data integrity and user privacy during transmission. This secure communication framework ensures that sensitive information exchanged between server 101 and remote devices 110 is safeguarded against unauthorized access or cyber threats. By maintaining a secure and efficient connection, system 100 provides users with reliable access to its features and data, thereby supporting effective interaction and engagement with system 100. The communication network 104's ability to integrate various technologies and devices underscores its critical role in maintaining a cohesive and functional system 100.

Each remote user device 110 is configured at least with a user interface (UI) and a communication module to connect via the communication module 104 and access the system 100. These devices 110 are adapted to run specific applications or interfaces that interact with the server 101, allowing users to perform tasks such as retrieving legislative information, submitting feedback, tracking bill progress, and analyzing voting behaviors. The configuration of the devices 110 enables them to offload complex processing tasks to server 101, thereby optimizing performance and ensuring a seamless user experience even on devices with limited computational resources. The remote user devices 110, such as smartphones, tablets, and laptops, allow users to interact with the server 101 from diverse locations. This interconnectedness ensures that users have real-time access to up-to-date information and system functionalities, enhancing overall efficiency and user experience.

System 100 includes the host computer or server 101 which serves as a central hub, managing the flow of information between the databases 102 and other components of the system 100. Server 102, in addition to storing essential data required for system operations, is adapted to fetch real-time updates from legislation-tracking databases 102 for any updates relating to bills and resolutions. This communication network 104 enables the system 100 to fetch and compile relevant information on legislative bills and the voting behaviors of political candidates, providing users with timely and accurate data. By leveraging these interconnected databases, the system 100 ensures that users can access a wealth of information, aiding in informed decision-making and analysis.

In particular, the server or host computer 101 in communication with the plurality of remote user devices 110 connected over the communication network 104, the host computer 101 is adapted to process and store data of the plurality of subscribers/users registered with the system 100, wherein the host computer 101 is adapted to fetch real-time information on a legislative bill published on at least one government website and broadcast the same to the plurality of remote user devices 110.

In an embodiment, the server 101 may be configured to run all of the plurality of modules, allowing it to handle all processing tasks centrally. Meanwhile, the remote user devices 110 can log into the server to access and utilize the features of the participative direct democracy system 100, ensuring that users can engage with the system's functionalities seamlessly from any location.

Said host computer or server 101 is further configured to execute a plurality of modules 101a-101g for the implementation of the disclosed participative direct democracy for voters in various political issues. These modules include a virtual alert module 101a, a virtual survey module 101b, a communication module 101c, a survey feedback processing module 101d, a legislator compliance module 101e, and a user reward module 101f. Each module operates collaboratively to provide comprehensive functionalities that enhance user interaction, feedback, and engagement with legislative processes.

The virtual alert module 101a is adapted to notify the users of important real-time updates and events regarding one or more legislative processes obtained from one or more authentic sources such as a government website. In an embodiment, the system 100 checks the database 102 for updates, and in case there is one on any bill or resolution, it sends a notification regarding the same to all the user devices 110 subscribed to the system 100. In an embodiment, the users need to first get registered to the system 100 through a registration process by providing their personal information. The user information is stored in the database 102 and based on a user selection, may be kept anonymous as well while participating in a given lobbying/influencing process.

The virtual survey module 101b of the remote user devices 110 is further configured to apply an AI-based filtering method to evaluate and filter one or more legislative bills. This filtering process takes into account various factors, including the subject matter of the bill, which is compared to a list of top trending national political issues. Additionally, the module 101b assesses local political issues that are relevant to local voters, enhancing the system's ability to tailor content to specific user interests and concerns. This AI-based approach ensures that users receive information that is pertinent to both national and local political landscapes.

Furthermore, the virtual survey module 101b utilizes advanced language learning models (LLMs) to enhance the filtering process. These LLMs analyze the legislative text in detail, evaluating the likelihood of passage of the legislative bill based on historical data, current political climate, and legislative trends. The LLMs also assess the potential impact of the legislative bill on individual states or localities, providing users with a comprehensive understanding of how the bill might affect their specific regions. This integration of LLMs allows for a more nuanced and precise filtering mechanism, delivering highly relevant legislative information to users.

In yet another alternate embodiment, the notification feature leverages user preferences to enhance engagement. Based on the preferences selected by the user, the system sends notifications about legislative bills that match their interests. This ensures that users are promptly informed about bills that are most relevant to them, allowing for timely and informed participation in the legislative process.

The use of AI-based filtering and LLMs in conjunction with user preferences creates a robust, personalized information delivery system within the virtual survey module.

For Example, a large number of proposed legislative bills are pending action. An AI-based filtering process is employed by the virtual survey module 101b to filter only those legislative bills that matter to voters. The most important legislative bills for voters may be identified by the system 100 from the subject matter of the bill compared to a top trending 25 National Political Issues or Local Political Issues available online. Another way is to determine the “prognosis” or likelihood of passage of a legislative bill that is likely to be passed and draw the immediate attention of the voter by generating an alert. Another method is determined from the geographical location impact of the bill on individual states or localities to affect local people by sending alerts to those voters who will be most impacted for immediate action.

Alternatively, the notification regarding the legislative action for a pending legislative bill is sent to a user based on a preference of said user, such as bills that impact the user's neighborhood.

In an embodiment, the virtual survey module 101b allows users to participate in one or more surveys and polls generated for seeking opinions on one or more pending legislative actions for lobbying in favor or against a political issue raised in the Parliament/Congress. In this, the communication module 101c facilitates interaction between the users 110 and the server 101.

In another embodiment, the virtual survey module 101b is further configured to update the surveys for local voters if the voting action of said elected representative aligns with the results of the opinion poll and notifies one or more users.

Further, the survey feedback module 101d collects and processes user responses or feedback on one or more polls conducted for one or more legislative issues; the legislator compliance module 101e tracks and ensures that elected representatives adhere to specified commitments and outcomes of the conducted poll; the user reward module 101f, which incentivizes user participation through various reward mechanisms; and the communication module 101c, which manages the communication protocols between the server 101 and remote devices 110. These modules collectively enable server 101 to handle core system operations, data processing, and user management effectively.

The host computer 101 is configured to execute the survey feedback processing module 101d to collect the responses from the remote user devices 110 via the communication network 104 and analyze said responses. The responses received for one or more survey polls are published by the host computer nationally for users to show the general will of the voters towards the pending legislative action. Additionally, the survey feedback processing module 101d is further configured to share the results of each of the opinion polls with one or more elected representatives in a given Parliament/Congressional setup corresponding to the geographic location of the said elected representatives. This feature aligns the results of the surveys with pending legislative votes, ensuring that amendments reflect the collective will of the people.

In an embodiment, the survey feedback processing module 101d anonymizes the response sent by a plurality of remote devices 110 to the server 101 before publishing the same or sending it to the elected representatives. Anonymizing ensures that individual user identities are protected by removing personally identifiable information (PII) from the responses. This is achieved through advanced data processing techniques, which include the use of encryption algorithms and data masking procedures to safeguard user privacy. By implementing these techniques, the system 100 ensures that the opinion poll results are shared in aggregate form, devoid of any data that could be traced back to individual users.

Moreover, the anonymizing process includes multiple layers of security to prevent re-identification of users. System 100 employs randomization methods and pseudonymization, replacing identifiable information with artificial identifiers. This guarantees that even when results are analyzed or cross-referenced with other datasets, the original identity of the respondents remains undisclosed. Thus, the survey feedback processing module 101d provides a secure and confidential mechanism for collecting, analyzing, and sharing user opinions with elected representatives, fostering trust and encouraging greater participation from users.

The host computer 101 further executes the legislator compliance module 101e configured to monitor the legislative action of each of the elected representatives related to the pending legislative bill for which the survey has been conducted. Said legislator compliance module 101e compares the results of the opinion poll with a voting action of each of the one or more elected representatives towards one or more legislative activities. This feature ensures that voters receive updates on the status of the commitments, fostering transparency in the legislative process.

The legislator compliance module 101e is further configured to send one or more elected representatives a notice of agreement if the voting action of one or more elected representatives aligns with the results of the opinion poll, or send a notice of disagreement if the voting action of the one or more elected representatives does not align with the results of the opinion poll. Said legislator compliance module 101e is configured to continually send the notice of disagreement for each legislative action until the voting action of one or more elected representatives aligns with the results of the opinion poll.

The legislator compliance module is further configured to add each of the elected representatives to a blacklist to whom at least one notice of disagreement is already sent, and further notify said elected representative of his/her inclusion on the blacklist. The legislator compliance module 101e is also configured to generate and send an online PR press release of disagreement to users, within the voting district of the one or more elected representatives added to the said blacklist, and to celebrity members for sharing on social media websites. Thus, the online system ensures that non-compliance to the will of the voters leads to tangible consequences, reinforcing the direct democracy ethos of government by the people. If an elected representative does not vote according to survey results, the disclosed system 100 holds them accountable through the Black List features. The blacklist may include names and websites of each of the elected representatives and is publicized continually at a pre-determined interval in all voting districts.

Additionally, the legislator compliance module is configured to implement additional deterrents or punishments selected from a predetermined list of deterrents linked with the number of times a notice of disagreement is sent to one or more elected representatives.

Said predetermined list of deterrents may include but are not limited to, online public pressure wherein the generated Blacklist may become a popular trending news list, creating public pressure for any elected representative who ends up on the permanently-online list that has a high ranking on searchable databases such as Google and Bing. It may also include in-public protests wherein if a representative fails to keep his/her promise, voters can organize public protest signs at their offices—creating negative press events that could damage the representative's reputation/political career, Loss of Financial and Volunteer Support wherein representatives who betray the trust of voters risk losing donations and volunteer support, Legal Action against the representative wherein the promise made by the representative during an event such as September 2nd Labor Day Event, is legally binding, and failure to fulfill said commitment results in legal consequences, social media campaigns that voters could launch to expose representatives failure to keep their commitments or will of the people, Organizing Petitions that include online public petitions on websites demanding representatives fulfills their commitments, lobbying other representatives who put pressure publicly or internally on the representative who went against the will of the people, initiation of a Vote of No Confidence for representative failing on their duties, Anti-Re-Election Campaigns wherein voters run campaigns against the representative for re-election in the next election cycle, boycotts certain businesses or organizations associated with the representative by informed voters, Virtual and In-Person Town Hall Meetings wherein voters could voice their concerns and dissatisfaction at town hall meetings and includes, but are not limited to, Public Debates for Voters to question the representative on the issues they have failed to address; and collaboration with other political movements or organizations to exert joint pressure on the representative, thereby, increasing the reach and impact of their efforts.

In another embodiment, the legislator compliance module 101e is configured to remove the name and website of each of the elected representatives and publicize the same if the voting action of each of the elected representatives aligns with the results of the opinion poll.

In a further embodiment, the host computer 101 comprises a user reward module 101f to reward each user who reviews, discusses, and votes on the legislative bills fetched from at least one government website. The feature motivates users/subscribers/voters to learn about the political issues that should matter to them because it will affect their lives. Said user reward module 101f includes an informed voter Sweepstakes that enables users to earn prizes, free stuff, tickets to sports games and concerts, etc.

Said features are sponsored by social-cause non-profits, foundations, and family office elections sponsors to monetize every “page view” thereby rewarding users for educating themselves using an AI-curated Social Cause, Election Issue, and Candidate Research part of the app. This converts any voter into an Informed Voter and pays them to become one, fostering a well-informed electorate ready to make decisions based on knowledge rather than rhetoric. This proactive involvement gives them a voice in shaping or halting proposed laws in state legislatures and Congress, making the legislative process more democratic and transparent.

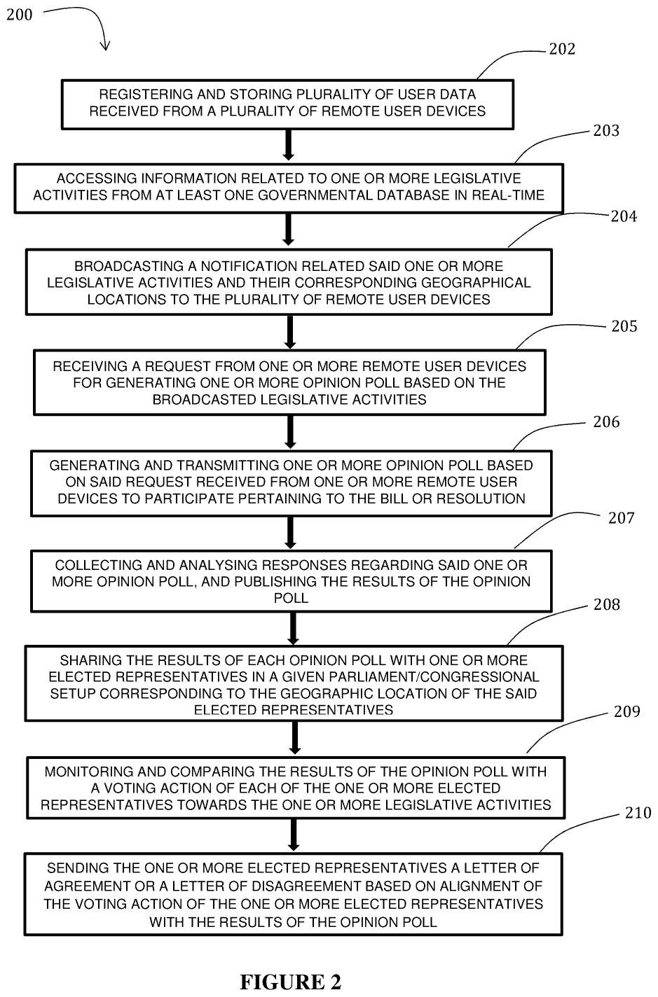

FIG. 2 illustrates a detailed flow diagram of method 200 to be implemented by the online system 100 for facilitating participative, direct democracy on political issues of FIG. 1, according to an embodiment of the present invention.

Said online method 200 for facilitating participative, direct democracy comprises Step 202, as a first step, for registering and storing user data of a plurality of subscribers/users by the server 101 which is in communication with the plurality of remote user devices 110 connected over the communication network 104.

User data refers to any information generated, provided, or collected from users as they interact with a system or application. This data encompasses a wide range of information types, including personal identifiers (such as names, addresses, and contact details), and contextual data (such as location, device information, and time stamps). User data is critical for tailoring user experiences, enhancing system functionality, and enabling personalized services. It is typically collected through various means, such as direct input from the user, automated tracking mechanisms, and integration with other data sources. Effective management and analysis of user data can provide valuable insights, drive decision-making processes, and support the continuous improvement of services and products offered by the system.

Further, in Step 203, information related to one or more legislative activities is accessed from at least one governmental database in real time. In Step 204, a notification related to said one or more legislative activities and their corresponding geographical locations is broadcasted to the plurality of remote user devices 110 by the server 101.

In an embodiment, the broadcasting step includes filtering said one or more legislative bills using an Artificial Intelligence (AI) based filtering algorithm. said AI-based filtering algorithm is configured to filter one or more legislative bills based on at least one of a subject matter of the bill compared to a list of top trending national political issues, local political Issues relevant to local voters, the likelihood of passage of the legislative bill, the impact of the legislative bill on individual states or localities of local people, or a user-determined preference.

In step 205, the method 200 includes receiving a request from one or more remote user devices 110 for generating one or more opinion polls based on the broadcasted legislative activities. Said responses are transmitted using a communication module, via the communication network 104, to the host computer 101 for further analysis and processing.

In Step 207, the method 200 further includes generating and transmitting one or more opinion polls based on said request received from the one or more remote user devices. Thereafter, at Step 208, the method includes collecting and analyzing responses regarding said one or more opinion polls, and publishing the results of the opinion polls.

In Step 209, the method 200 comprises sharing the results of each opinion poll with one or more elected representatives in a given parliament/congressional setup corresponding to the geographic location of the said elected representatives. The publishing and sharing steps include anonymizing the user responses to protect user identity.

Anonymizing user data involves transforming personally identifiable information (PII) within a dataset in such a way that the individuals whom the data describes cannot be readily identified. This process is essential for protecting user privacy while enabling data analysis and utilization. Techniques for anonymizing user data include data masking, where specific fields within a dataset are obscured or replaced with pseudonyms; aggregation, where data is combined in such a manner that individual user details are indistinguishable; and encryption, where data is encoded so that it can only be accessed by authorized parties with the appropriate decryption keys. Anonymization helps organizations comply with data protection regulations and maintain user trust, while still allowing for valuable insights to be derived from the data through techniques like statistical analysis and machine learning.

At step 209, the method 200 includes monitoring and comparing the results of the opinion poll with a voting action of each of the one or more elected representatives towards the one or more legislative activities.

At Step 210, the method 200 includes sending the one or more elected representatives a notice of agreement if the voting action of the one or more elected representatives aligns with the results of the opinion poll, or sending the one or more elected representatives a notice of disagreement if the voting action of the one or more elected representatives do not align with the results of the opinion poll.

In a further aspect, the method 200 involves transmitting repetitively the notice of disagreement until the voting action of the one or more elected representatives aligns with the results of the opinion poll(s).

In yet another embodiment, the method 200 includes creating a blacklist and adding the name and website of one or more elected representatives to whom at least one notice of disagreement is sent, and notifying the respective elected representative of said addition. The method 200 also includes publicizing continually the blacklist at a pre-determined interval in all voting districts. Additionally, said method 200 also includes generating and transmitting an online PR press release of disagreement to users within the voting district of the blacklisted elected representatives, and to celebrity members for sharing on social media websites.

In an alternate embodiment, the method 200 comprises implementing additional deterrents or punishments selected from a predetermined list of deterrents based on the number of times the notice of disagreement is sent to one or more elected representatives.

For Example, survey results, by the disclosed online system and method, are made public and sent to local legislators to show what their anonymous but registered constituents think. Representative compliance is gauged on the day of the vote to ascertain whether the representative votes according to the will of the people or against them. If it is observed that the representative is aligned with the will of the people, a 1st Notice of Agreement and thank you. If the representative goes against the will of the people then a Notice of Disagreement is sent putting said representative on notice of Probation.

On a subsequent act of voting for the proposed legislation, if the representative is again found to go against the will of the people then a Notice of Black List is sent and publicized. A third act of voting that is in disagreement with the will of the people, then ever-escalating Deterrents are chosen from a pre-determined list to compel compliance by voting according to the will of the people.

The provided solution includes numerous deterrence and negative effects for non-compliance such as facing a withdrawal of campaign donations from subscribers/members of the online system; ‘Blacklisting’ wherein publicly naming politicians who have not upheld their oath of honesty and truthfulness, serving as a form of social accountability; reputational damage among voters, which can have long-term effects on their political careers. Thus, non-compliance leads to tangible consequences, reinforcing the direct democracy ethos of government by the people. This holds politicians accountable for their actions and deters them from engaging in dishonest behavior. Accountability of politicians who have been caught lying to voters or posting misinformation or lies on social media or who have violated their promise to follow the will of local voters is achieved by the present invention.

The method 200 also involves removing the names and websites of each of the elected representatives if the voting action of said elected representative aligns with the results of the opinion poll. Additionally, the method 200 includes updating the generated opinion poll if the voting action of said elected representative aligns with the results of the opinion poll and notifies the one or more users.

In another embodiment, the method 200 further comprises rewarding each user who reviews, discusses, and votes on the legislative bills fetched from at least one government website. The proposed incentives for voters to use the online system compensate and reward voters for deepening their understanding of election issues and empowering them to make informed choices about the laws that need to be enacted to address the challenges that have beset America over the last 30 years of moral decline. The rewards for informed voters are not monetary. Instead, voters are rewarded with experiences and opportunities in the form of complimentary items, such as tickets to entertainment and sports events, and corporate gift cards from Informed Voter sponsors.

By rewarding voters for staying informed and engaged, disclosed invention helps to combat voter apathy and increase turnout. It also encourages continuous learning and engagement with political issues, fostering a more informed electorate. Disclosed invention provides points for participation for every opinion shared or vote cast on amendments of pending legislation, users accumulate points. This not only incentivizes staying informed but also encourages active contribution to the political discourse.

Users can further use their points to ‘purchase’ rewards, such as event tickets or local business vouchers. Additionally, by sharing messages from celebrities or informative content about election issues, users can earn extra points. This aspect turns the proposed online system into a social platform where informed opinions are not just heard but also rewarded. By partnering with local businesses and corporations, the proposed solution could offer a variety of rewards, from entertainment tickets to discounts at retail stores. This not only incentivizes users but also supports local economies. Further, foundations and family offices could sponsor the reward system, underlining their commitment to an informed electorate and robust democracy. Users may also choose rewards that resonate with them, creating a personalized experience that acknowledges their efforts and preferences.

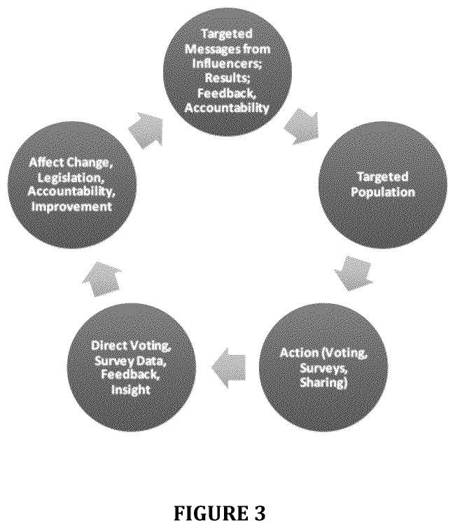

FIG. 3 illustrates the key features, and workflows of the online system for facilitating participative, direct democracy, according to an embodiment of the present invention.

The present system and method include utilizing surveys or polls related to the legislative process or issues that are shared with multiple users for gauging the voter's opinion on the legislative process. The disclosed invention captures voters/users/subscribers' opinions on the legislative process and integrates it with the opinion or voting pattern of their elected representative. The proposed system and method analyze and continually monitor the voting behavior of the elected representative and simultaneously inform the subscribers.

The system and method incorporate various modules to hold the elected representative accountable for their voting behavior towards a legislative bill that may affect the subscribers registered on the system. Several deterrent measures are specifically designed to force the elected representative to follow the will of the people, thereby committing to the promises made towards their constituencies during their election campaign.

The disclosed system and invention representative commitments to pass the laws that address the major issues identified by voters and align their legislative votes with the results of our surveys are monitored continuously. The disclosed invention put up numerous deterrent methods for non-compliance by elected officials. The invention provides tracks of commitments made by candidates and elected officials, specifically their commitment to pass the laws aimed at addressing the major problems identified by voters. The provided solution aligns the results of the surveys with pending legislative votes, ensuring that amendments reflect the collective will of the people. Further, Real-Time Updates to voters on the status of commitments foster transparency in the legislative process.

The proposed solution provides citizens with several opportunities to provide feedback to their elected representatives at various stages of the legislative process, such as upon introductions of bills in Congress or state legislatures, as the first opportunity for feedback. As a second opportunity, when the bill is assigned to a committee, citizens can submit their opinions during public hearings or directly to committee members and is considered a critical stage where bills are examined in detail. A third opportunity is when the bill is reported favorably by a committee, it moves to the floor for consideration during which citizens can lobby their representatives. A Fourth opportunity is when both in committees and on the floor, bills can be amended. As a fifth opportunity before the final vote to contact their representatives to influence their vote. Another opportunity is provided if the House and Senate pass different versions of a bill, a conference committee is formed to reconcile differences. As a last opportunity after Congress passes a bill, but before it is signed by the President, citizens can still express their views, potentially influencing the President's decision to sign or veto.

The disclosed solution leverages each opportunity by utilizing the Virtual Alert and Survey to alert users/citizens/voters to give their opinion on the proposed bill or amendment. The inventive steps to accomplish the important task of holding elected officials accountable is to encourage them to vote according to their constituent voter opinions. Voter Alert combined with Voter Survey to gauge public opinion in the form of opinion poll voting of how voters want their elected representative to vote on the proposed law/amendment.

The provided solution also attracts non-voters with the prospect of tangible rewards thereby motivating the 80 million non-voters from the 2020 presidential election to become active participants in the democratic process. The proposed reward system encourages users to become well-informed voters, leading to more intelligent voting decisions that reflect the community's needs. Independent voters, often seeking non-partisan information, my find the proposed online system particularly useful for making informed choices without the influence of party bias.

The proposed solution transforms social media users into a cohesive voting bloc, thereby playing a pivotal role in shaping election outcomes and ensuring that government actions align with the will of the people. The reward system further provides a sense of accomplishment, as users can see the direct results of their civic involvement. Users are also motivated by the knowledge that their informed votes contribute to the betterment of society. Thus, the proposed solution also combats voter apathy by making political engagement as rewarding as scrolling through social media for entertainment.

The online platform is an end-to-end comprehensive and dynamic solution that continues to increase in value and power with use and critical mass. Where other political and social apps fall short, the provided solution fills in the gaps. It is intended to be a powerful and fully-integrated platform that ultimately serves as a virtuous cycle, that feeds itself and grows its ecosystem.

What is claimed is:

1. A computer-implemented online system for facilitating participative, direct democracy, said system comprising:
a host computer in communication with a plurality of remote user devices connected over a communication network, the host computer adapted to store and process data of a plurality of users registered with the system through respective remote user devices, wherein the host computer comprises:
a virtual Alert module implemented as software executed on the host computer, configured to retrieve, information about one or more legislative activities in real-time and their corresponding geographical location from at least one legislation-tracking database;
a communication module, implemented as software for execution on the host computer, configured to notify, via a user interface, said information about one or more legislative activities in real-time to one or more users associated with each remote device according to their geographical location and receive, via the user interface, requests from one or more users to generate one or more opinion polls for said one or more legislative activities;
a virtual survey module, implemented as software for execution on the host computer, configured to generate, one or more opinion polls for each one of the legislative activities, and transmit via the communication module said one or more opinion polls to said users, via the user interface, based on said requests from one or more users;
a survey feedback processing module, implemented as software for execution on the host computer, configured to collect and analyze responses of said opinion polls, received from each of the remote device via the user interface, and publish poll results, wherein the survey feedback processing module is further configured to share the results of each of the opinion polls with one or more elected representatives in a given Parliament/Congressional setup corresponding to the geographic location of the said one or more elected representatives;
a legislator compliance module implemented as software for execution on the host computer, configured to monitor and compare the results of each of the opinion polls, stored in the host computer, with a voting action of each of the one or more elected representatives, retrieved by the virtual Alert module from at least one legislation-tracking database, towards one or more legislative activities, wherein the legislator compliance module is configured to:
send the one or more elected representatives, via the communication module, a notice of agreement if the voting action of the one or more elected representatives aligns with the results of the opinion poll, and
a notice of disagreement if the voting action of the one or more elected representatives does not align with the results of the opinion poll,
wherein the legislator compliance module is configured to create and add names and websites of each of the elected representatives to a blacklist to whom at least one notice of disagreement is sent, and further notify said elected representative of the blacklist.

2. The system of claim 1, wherein each of the plurality of remote user devices includes at least a user interface to display information and receive responses, and a communication module to receive and transmit information to said host computer.

3. The system of claim 1, wherein the plurality of remote user devices are selected from smartphones, tablets, wearable devices, laptops, and smart home devices.

4. The system of claim 1, wherein the legislation-tracking database is selected from a federal database maintained by the federal government, a state database maintained by a state legislative body, or a private/corporate legislation-tracking database maintained by an owner/provider.

5. The system of claim 1, wherein the virtual alert module is further configured to filter one or more legislative bills using an Artificial Intelligence (AI) based filtering algorithm.

6. The system of claim 5, wherein said AI-based filtering algorithm is configured to filter one or more legislative bills based on at least one of a subject matter of the bill compared to a list of top trending national political issues, local political Issues relevant to local voters, the likelihood of passage of the legislative bill, or the impact of the legislative bill on individual states or localities of local people.

7. The system of claim 1, wherein the survey feedback processing module is configured to anonymize user responses before sharing the results of the opinion polls with one or more elected representatives.

8. The system of claim 1, wherein the legislator compliance module is configured to continually monitor and send the notice of disagreement for each legislative action until the voting action of one or more elected representatives aligns with the results of the opinion poll(s).

9. (canceled)

10. The system of claim 1, wherein the legislator compliance module is further configured to generate and send an online PR press release of disagreement to local news media and users within the voting district of the one or more elected representatives added to said blacklist, and to celebrity members for sharing on social media websites.

11. The system of claim 1, wherein the legislator compliance module is further configured to implement additional deterrents selected from a predetermined list of deterrents linked with the number of times a notice of disagreement is sent to one or more elected representatives.

12. The system of claim 1, wherein the legislator compliance module is configured to remove the name and website of each of the elected representatives from the blacklist if the voting action of said elected representative aligns with the results of the opinion poll and publicizes the same.

13. The system of claim 1, wherein the legislator compliance module is further configured to update the surveys for local voters if the voting action of said elected representative aligns with the results of the opinion poll, and notify one or more users.

14. The system of claim 1, wherein the host computer further comprises a user reward module implemented as software and configured to reward each user who reviews, discusses, and votes on the legislative bills fetched from at least one government website.

15. An online method for facilitating participative, direct democracy, said method comprises:
registering and storing a plurality of user data received from a plurality of remote user devices;
accessing information related to one or more legislative activities from at least one governmental legislation-tracking database in real-time;
broadcasting a notification related to said one or more legislative activities and their corresponding geographical locations to the plurality of remote user devices;
receiving a request from one or more remote user devices for generating one or more opinion polls based on the broadcasted legislative activities;
generating and transmitting one or more opinion polls based on said request received from one or more remote user devices;
collecting and analyzing responses regarding said one or more opinion polls, and publishing the results of the opinion poll, wherein the method further comprises:
sharing the results of each opinion poll with one or more elected representatives in a given Parliament/Congressional setup corresponding to the geographic location of the said elected representatives;
monitoring and comparing the results of the opinion poll with a voting action of each of the one or more elected representatives towards the one or more legislative activities, wherein the method is configured for:
sending the one or more elected representatives a notice of agreement where the voting action of the one or more elected representatives aligns with the results of the opinion poll, and
a notice of disagreement where the voting action of the one or more elected representatives does not align with the results of the opinion poll,
wherein said monitoring and comparing step includes creating a blacklist and adding the name and website of one or more elected representatives to whom at least one notice of disagreement is sent, and notifying respective elected representatives of said addition.

16. The method of claim 15, wherein said broadcasting step includes filtering said one or more legislative bills using an Artificial Intelligence (AI) based filtering algorithm.

17. The method of claim 16, wherein said AI-based filtering algorithm is configured to filter one or more legislative bills based on at least one of a subject matter of the bill compared to a list of top trending national political issues, local political Issues relevant to local voters, the likelihood of passage of the legislative bill, the impact of the legislative bill on individual states or localities of local people, or a user-determined preference.

18. The method of claim 15, wherein said publishing and sharing steps include anonymizing the user responses to protect user identity.

19. The method of claim 15, wherein the monitoring and comparing step includes transmitting repetitively the notice of disagreement, based on continued monitoring of the voting action, until said voting action of the one or more elected representatives aligns with the results of the opinion poll.

20. (canceled)

21. The method of claim 15, wherein the blacklist is publicized continually at a pre-determined interval in all voting districts.

22. The method of claim 15, wherein said monitoring and comparing step further includes generating and transmitting an online PR press release based on the notice of disagreement to local news media and users within the voting district of the blacklisted elected representatives, and to celebrity members for sharing on social media websites.

23. The method of claim 22, wherein said monitoring and comparing step further includes implementing additional deterrents selected from a predetermined list of deterrents based on the number of times the notice of disagreement is sent to one or more elected representatives.

24. The method of claim 15, wherein said monitoring and comparing step includes removing the names and websites of each of the elected representatives if the voting action of said elected representative aligns with the results of the opinion poll.

25. The online method of claim 15, wherein the monitoring and comparing step further includes updating the generated opinion poll if the voting action of said elected representative aligns with the results of the opinion poll and notifying one or more users.

26. The online method of claim 15, wherein said method further comprises rewarding each user who reviews, discusses, and votes on the legislative bills fetched from at least one legislation-tracking website.
